(19) United States
(12) Patent Application Publication
(10) Pub. No.: US 2010/0040861 A1
(43) Pub. Date: Feb. 18, 2010

(54) Ordered Mesoporous Free-Standing Carbon Films And Form Factors

(76) Inventors: William Peter Addiego, Big Flats, NY (US); Wageesha Senaratne, Horseheads, NY (US)

Correspondence Address: CORNING INCORPORATED, SP-TI-3-1, CORNING, NY, 14831, US

(21) Appl. No.: 12/190,937

(22) Filed: Aug. 13, 2008

(51) Int. Cl. B32B 3/26; B05D 3/00

(52) U.S. Cl. 428/306.6; 427/379; 427/382; 427/381; 428/315.5

(57) ABSTRACT

Free-standing ordered mesoporous carbon films and form factors are prepared by depositing an aqueous precursor mixture that includes a water soluble carbon precursor, a non-ionic surfactant, and an oil onto a substrate or scaffold, drying the precursor mixture, and then cross-linking and heat treating (carbonizing) the carbon precursor. After carbonization, the ordered mesoporous carbon films and form factors include discrete domains of ordered, mesoscale pores.

### BACKGROUND AND SUMMARY

The present invention relates to a method of forming free-standing ordered mesoporous carbon films and form factors. The method comprises forming a precursor mixture containing a carbon precursor, at least one surfactant, oil, and water, depositing the precursor mixture onto a substrate, and then drying, cross-linking and heat treating (carbonizing) the carbon precursor to form the carbon film or form factor. The invention also relates to the carbon films and form factors made according to the method. Advantageously, both the macroscale and mesoporous morphology of the films and form factors can be controlled by varying process conditions such as the ratio of carbon precursor: surfactant: oil:water in the precursor mixture, the choice of substrate, and the drying and carbonizing conditions.

Ordered mesoporous carbon materials comprise a three-dimensionally ordered and interconnected array of pores that range in size from about 2 to 50 nm. Ordered mesoporous carbons can exhibit BET specific surface areas as high as about 2200 m²/g, and typically exhibit excellent thermal stability in inert atmospheres, and strong resistance to attack by acids and bases. In preferred synthesis routes for making ordered mesoporous carbons, the macro geometry, pore geometry and surface chemistry, including the optional incorporation of surface active species, can be tailored according to the desired application.

Ordered mesoporous carbons can be used in a variety of applications, including water/air purification, gas separation, filtration, catalysis, adsorption, chromatographic separations, capacitive deionization, electrochemical double-layer capacitors, ultracapacitors, and hydrogen storage.

In accordance with the present invention, Applicants have determined that free-standing carbon films and form factors comprising ordered mesoporous carbon material can be prepared, for example, by depositing an aqueous precursor mixture comprising a water soluble carbon precursor, a non-ionic surfactant, an oil and water onto a substrate or scaffold, drying and cross-linking the precursor mixture, and heat treating the coated substrate or scaffold. After deposition of the precursor mixture, but before cross-linking of the carbon precursor, self-assembly of the surfactant forms a template for the carbon precursor. After carbonization, the carbon films and form factors comprise ordered domains of mesoscale porosity.

Free-standing carbon films having a film thickness ranging from about 100-500 micrometers can be formed using the inventive method. According to one preferred method for forming a free-standing carbon film, a thin layer of the precursor mixture is deposited onto a first substrate and the as-deposited layer is sandwiched between the first substrate and a second substrate. After drying and cross-linking, the deposited layer is transformed by heating into a free-standing ordered mesoporous carbon film via thermally-induced removal (e.g., pyrolysis) of the solvents and the surfactant-based organic template.

Form factors can be prepared using a similar process wherein the precursor mixture is deposited onto a scaffold. Scaffolds can be organic or inorganic, and can include paper, cloth or foam. Once the as-deposited layer is coated onto the scaffold, it is cross-linked and carbonized by heating. Because the scaffold material can be organic, the scaffold can be volatilized during the heat treating step and/or incorporated into the form factor. Because the precursor mixture coats exposed surfaces of the scaffold, the form factor comprises a positive image of the scaffold from which it is derived.

Using such a technique, complex geometries such as ordered mesoporous carbon foam blocks, honeycombs, corrugated plates and other reticulated structures can be produced. Preferred form factors comprise a carbon film-coated reticulated scaffold wherein the carbon film comprises ordered mesoporous carbon.

As with the carbon films, Applicants have discovered that ordered domains of mesoscale pores are retained in these complex geometries even after carbonization. Thus, the ordered mesoporous carbon films and form factors according to the invention can be defined by a structure that is ordered at the nanoscale as well as at larger dimensions, e.g., micro-scale ordering corresponding to the substrate or scaffold.

Once formed, the ordered mesoporous carbon films and form factors can be activated. The optional activation, which can comprise partially oxidizing surfaces of the carbon material and generally involves a concomitant increase in surface area, can comprise thermal and/or chemical activation.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a schematic flow chart of a process for forming ordered mesoporous carbon films and form factors;

FIGS. 2A-2C show scanning electron micrographs for ordered mesoporous carbon form factors prepared using (A) foam, (B) cloth, and (C) paper towel organic scaffolds;

FIG. 3 shows plots of X-ray diffraction data for ordered mesoporous carbon (a) powder, (b) carbonized foam, and (c) carbonized cloth;

FIG. 4 shows scanning electron micrographs for carbon material prepared using a foam scaffold (comparative);

FIG. 5 is series of scanning electron micrographs showing pore orientation in free-standing ordered mesoporous carbon films;

FIG. 6 is a series of scanning electron micrographs showing (a) a cross sectional view, (b) a bottom surface, and (c) a top surface of ordered mesoporous carbon films on aluminum and Pyrex® brand substrates;

FIG. 7 shows X-ray diffraction plots for ordered mesoporous carbon powder and a free-standing film showing reflections for (a) powder, (b) film top surface, and (c) film bottom surface;

### DETAILED DESCRIPTION

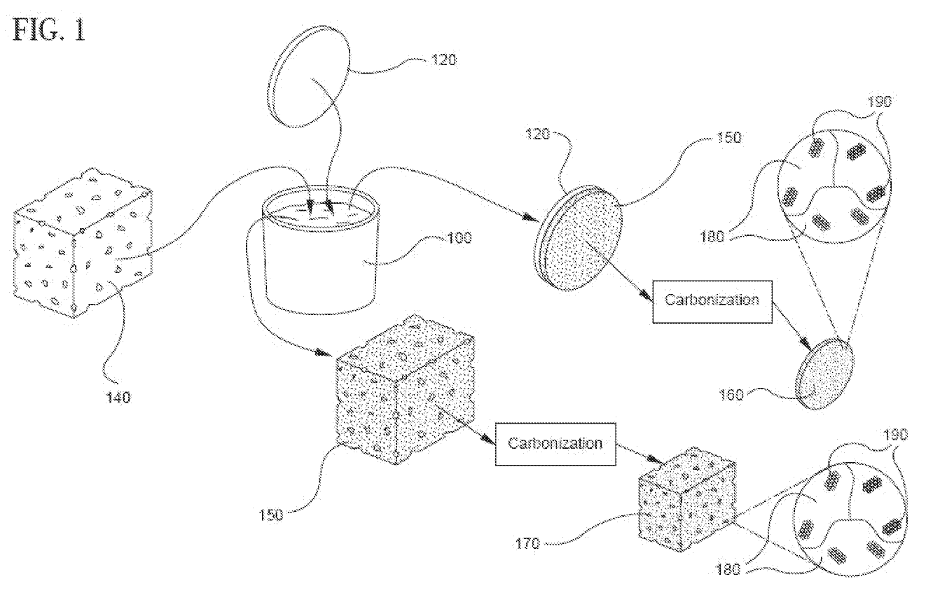

FIG. 1 is a schematic flow chart depicting examples of processes for forming ordered mesoporous carbon films and form factors. Referring to FIG. 1, a precursor mixture 100 comprising an aqueous mixture of a carbon precursor, a surfactant, and an oil is coated onto a substrate 120 or scaffold 140 and dried to form a cross-linked coating 150 comprising a mesostructure phase. The mesostructure phase is defined by the self-assembly of an organic template (e.g., liquid crystal phase) that comprises the surfactant. The carbon precursor, which is ordered by the organic template, is carbonized by heating to form an ordered mesoporous carbon film 160 or form factor 170 having domains 180 of ordered pores 190. During the step of heat treating, the substrate 120 or scaffold 140 can be at least partially volatilized and/or incorporated into the film 160 or form factor 170.

In particular, the ordered mesoporous carbon material is formed from a concentrated precursor mixture comprising: i) a water-soluble carbon precursor/H₂O solution, ii) a non-ionic surfactant, and iii) an oil, which is dried to form a surfactant-based self-assembly in which the surfactant defines, and the cross-linked carbon precursor stabilizes, the mesostructure phase. As a result of heating, the mesostructure phase is transformed via the sequential removal of solvent(s) and the surfactant-based template into an ordered mesoporous carbon film or form factor.

By selecting the appropriate composition and concentration of the precursor mixture, it is possible to control physical properties of the resulting ordered mesoporous carbon material such as the macroscale morphology, domain size, and the pore size and pore size distribution. Techniques for selecting suitable ratios of carbon precursor/H₂O: surfactant:oil, and methods for controlling the physical properties of the ordered mesoporous carbon material based on these ratios are disclosed in commonly-owned U.S. patent application Ser. No. 11/899,002, the entire contents of which are expressly incorporated herein by reference in their entirety.

The ordered mesoporous carbon films and form factors made in accordance with the present invention preferably have oriented, uniform, mesopore diameter (2-50 nm) pores, high surface area, and good mechanical strength. In addition to controlling the composition and concentration of the precursor mixture, these physical attributes can be controlled by adjusting other process variables such as humidity, pH, drying conditions, cross-linking conditions, heat treating conditions, and the choice of substrate or scaffold.

Other aspects and advantages of the invention are disclosed below:

Materials

The precursor mixture used to form ordered mesoporous carbon films and form factors includes a carbon precursor/H₂O, a surfactant, and an oil. An example of a carbon precursor is 510D50 phenolic resin (Georgia Pacific), which comprises two different molecular weight species (GPC data, Mₙ˜2800 and ˜1060). Additional suitable water-soluble carbon precursors include thermosetting carbohydrates, polyvinylalcohols, resorcinol-formaldehyde, peptide amphiphiles, lipids, and other phenolic resins.

Useful surfactants are PEOy-PPOx-PEOy tri-block co-polymers available from BASF, Inc. In particular, Pluronic™ F127 (x=106, y=70) and Pluronic™ F108 (x=127, y=50) were used in conjunction with the inventive method to produce both free-standing carbon films and form factors. Additional non-ionic surfactants include Pluronic™ P123 (x=20, y=70) and Pluronic™ F88 (x=104, y 39).

The surfactant functions as a removable organic template for the carbon precursor. The amount of water and oil that are incorporated into the precursor mixture can be used to manipulate the self-assemblage of the surfactant through its liquid crystal phases and, in turn, the mesoporous structure and properties of the resulting mesoporous carbon material. Specifically, the chemistry of the precursor mixture can be used to control, for example, the resulting pore diameter and pore volume.

In precursor mixtures comprising a PEOy-PPOx-PEOy tri-block co-polymer, the oil acts as a swelling agent for the PPO block. The concentration of oil in the precursor mixture can be used to control the swelling of the hydrophobic part of the micelle structure, and can also control the pore size and pore mesostructure of the resulting ordered mesoporous carbons. The addition of oil changes the aqueous mixture from a two phase system to a three phase system. The oil also expands the range of the water, surfactant and carbon precursor compositions within which a particular mesostructure is stable.

An example of an oil is butanol. However, in lieu of or in addition to butanol, other suitable oils (water-immiscible liquids) include p-xylene, octane, hexadecane, hexanol, pentanol, butyl acetate and mesitylene.

The concentration of water in the precursor mixture can be used to control the assemblage of mesoporous channels in both the cross-linked material and in the heat treated (carbonized) product. In precursor mixtures comprising PEOy-PPOx-PEOy tri-block co-polymers, water interacts with the PEO blocks and, by swelling the phase containing the carbon precursor, can affect the self-assembly of the surfactant template. The carbon precursor:water ratio can be varied over a wide range of compositions. For example, the precursor mixture can have a carbon precursor:water ratio ranging from 5:0 to 1:4 (e.g., 5:0, 4:1, 3:2, 2:3, and 1:4).

Synthesis

In a typical synthesis, the PEOx-PPOy-PEOx tri-block co-polymer (e.g., 3.7 g Pluronic™ F127) is added to absolute ethanol (18% F127 in 20 ml of ethanol) and stirred with applied heat until the co-polymer is at least partially dissolved in the ethanol. A known quantity of de-ionized water (e.g., 1.4 ml) is added to the mixture, which results in further dissolution of the co-polymer. After stirring for several minutes, the phenolic resin (3.0 ml) is added slowly to the mixture followed by vigorous stirring. Butanol (1.5 ml) is then added to the mixture followed by continued stirring to produce precursor mixture A. Optionally, 5N HCl (0.6 ml) can be added to precursor mixture A to completely dissolve the co-polymer. The precursor mixture is preferably stirred at room temperature for 20-30 minutes prior to use.

Coating

A preferred method of coating a substrate or scaffold with a precursor mixture is dip-coating. With dip-coating, the substrate or scaffold is immersed into a bath of the precursor mixture whereby the precursor mixture forms a layer over exposed surfaces of the substrate or scaffold. In the scaffold embodiment, coated surfaces include both visible surfaces as well as surfaces within the interior of the scaffold, i.e., surfaces that are coated via infiltration and/or impregnation of the precursor mixture. The step of dip-coating can be repeated, which can result in a thicker coating. Individual dip-coating steps can be performed in succession, or separated by one or more of the step(s) of drying, cross-linking, and heat treating.

In addition to dip-coating, precursor mixtures can be coated onto substrates or scaffolds by spin coating, spray coating, casting, etc., and then dried, cross-linked and heat treated to form carbon films and form factors. Optionally, prior to drying, excess precursor mixture can be removed from the substrate or scaffold using a variety of techniques. For example, an elastic foam substrate can be pressed to remove excess precursor.

As noted above, the substrate or scaffold can comprise an organic or an inorganic material, and can be a porous or substantially non-porous material. Examples of suitable (porous or non-porous) organic materials include polymer foams, beads, fibers, sheets and coatings, paper, cloth, and other cellulose-based materials. Examples of suitable inorganic materials include carbon, glasses, ceramics, semiconductors, and metals. In addition, a variety of different scaffold structures or geometries can be used. For example, suitable scaffolds can comprise honeycombs, foams, fibers, corrugated sheets or plates, etc.

Drying and Cross-Linking

The drying comprises evaporation of the water and other volatile liquids to form an ordered pre-carbonized mesostructure phase. In a preferred drying step, the coated substrate or scaffold is dried at room temperature for a specified time (e.g., 1, 2, 3 or more hours). The ordered pre-carbonized mesostructure phase is defined by a self-assembled surfactant (e.g., tri-block co-polymer) and an at least partially cross-linked carbon precursor (e.g., phenolic resin). The self-assembled surfactant functions as a template that facilitates ordering of the carbon precursor within the pre-carbonized mesostructure phase.

After the drying step, the carbon precursor is cross-linked. To perform the cross-linking, in an embodiment, samples are placed in a desiccator and heated according to the cross-linking cycle disclosed in Table 1.

TABLE 1
Heating cycle for resin cross-linking

| Initial Temp. | Final Temp. | Heating Rate | |
|---|---|---|---|
| [° C.] | [° C.] | [° C./min] | Hold time [hr] |
| 50 | 80 | 0.1 | 3 |
| 80 | 95 | 0.1 | 3 |
| 95 | 110 | 0.1 | 2 |
| 110 | 125 | 0.1 | 2 |
| 125 | 150 | 10 | 1 |
| 150 | 50 | 5 | |

Cross-linking stabilizes the pre-carbonized mesostructure phase. Prior to the heat treatment, cross-linked membranes can have a thickness of about 150 to 700 micrometers, which, as disclosed below, are reduced upon carbonization by approximately 20-30%.

Heat Treatment (Carbonization)

To carbonize the carbon precursor, the cross-linked membrane-coated substrates or scaffolds can be, for example, heated in an oven in a nitrogen atmosphere according to a predetermined heating profile. According to one embodiment, samples are heated at a first heating rate to 400° C. for 3 hr to volatilize the surfactant, and then heated at a second heating rate to 800° C. for 3 hr to carbonize the carbon precursor. Thermogravimetric analysis data indicates that the surfactant template is decomposed and volatilized at a temperature between 300° C. and 400° C.

The first and second heating rates can range from 0.1 to 5° C./min. For example, the first heating rate can be about 2° C./min, and the second heating rate can be about 1° C./min. A preferred heat treatment step comprises initially heating at 2° C./min to 400° C. for 3 hr, then heating at 1° C./min to 800° C. for 3 hr prior to cooling to room temperature.

In embodiments where an organic scaffold is used, a majority of the organic scaffold (carbon material) can be incorporated into the reticulated structure of the ordered mesoporous carbon product.

Once formed, the ordered mesoporous carbon material comprises domains of well-aligned mesoscale porosity. The process of forming a carbon film on a substrate or scaffold can result in a post-carbonization pore alignment that is generally perpendicular to the substrate or scaffold surface. A method of forming an ordered mesoporous carbon film further comprises removing the film from the substrate to form a free-standing film.

Due to the uniformity of pore alignment, the inventive process can produce carbon material having a higher effectiveness factor than carbon produced by conventional methods. The effectiveness factor relates to the fraction of surface area that is accessible or exposed to reacting or adsorbing species.

The inventive ordered mesoporous carbon films and form factors can have an effectiveness factor greater than about 75%. Such structures can perform more effectively as filters or catalyst substrates than conventional carbon powders because of a higher available surface area, and the relative ease and enhanced efficiency associated with incorporating the films and form factors into filter apparatus and reactors. For example, reticulated form factors such as foam blocks, corrugated plates, honeycombs, and interlaced fibers can provide flexible reactor design, easy material loading and unloading, and better temporal control of flow conditions by minimizing clogging and flow pattern disruption. The ordered arrays of pores allow engineers to design reactor geometries that accommodate flow conditions and take advantage of the ordered mesoporous carbon reactive surfaces. Such structures can also improve exposure to reactants and minimize mass transfer limitations. Ordered mesoporous carbon (post-carbonization) films can have a thickness ranging from about 100 to 500 micrometers.

Activation/Functionalization (Optional)

The ordered mesoporous carbon material produced via the heat treatment step can optionally be activated in order to increase its available surface area or otherwise enhance its activity. The activation step can also modify the pore size distribution within the ordered mesoporous carbon. For instance, the activation can introduce micro pores (<2 nm) into the mesoporous structure.

The activation step can comprise one or more of a thermal activation step or a chemical activation step. For example, the ordered mesoporous carbon material can be activated by heating to an elevated temperature (e.g., 500-1000° C.) in a CO₂ or steam (H₂O) atmosphere. As a further example, the structured carbon can be activated via solution redox chemistry using an oxidizing agent. In addition to increasing the surface area of the carbon material, the oxidizing agent can also be used to control the pore size and pore size distribution.

The activation partially oxidizes the surface of the carbon material, but advantageously leaves intact the structured array of carbon channels. The activation process also provides active sites for ion exchange with active species or catalysts along the internal surfaces within the channels. As a result of the carbonization and activation processes, the carbon material can be used as an active filter, membrane, or catalyst support.

Alternatively, or in addition to chemical or thermal activation of the ordered mesoporous carbon material, carbon surfaces can, if desired, be chemically functionalized and/or charged by using electrostatics in a post-carbonization step. In one example disclosed below, an ordered mesoporous carbon film was activated and functionalized.

According to one method of forming a free-standing ordered mesoporous carbon film, a precursor mixture is coated onto at least one of two different substrates, and prior to carbonizing, the substrates are brought together in order to sandwich the deposited layer(s) between the substrates. Subsequent drying, cross-linking, and heat treating of the deposited layer(s) within the substrate/deposited layer(s)/substrate stack can produce a free-standing, ordered mesoporous carbon film.

According to a further example, a precursor mixture is dip-coated onto a ceramic honeycomb substrate, dried, cross-linked and heat treated. The carbon film-coated honeycomb substrate is activated by heating in flowing CO₂/N₂ at 900 ° C. The sample is then immersed into a room temperature solution of HAuCl₄ and urea at pH<4, and the solution temperature is raised to −80° C. under constant stirring. The increase in temperature induces decomposition of the urea, a concomitant increase in pH, and the precipitation and deposition of fine gold particles on the carbon.

Other methods of depositing catalyst particles on exposed surfaces of ordered mesoporous carbon include ion-exchange and immobilization of catalyst (metal) sols.

With reference to the foregoing, a free-standing, ordered mesoporous carbon (OMC) thin film comprises an amorphous carbon network having parallel pores, or channels, that form ordered domains of nanoscale (mesoscale) porosity. Individual pore diameters can range from about 2 to 50 nm, while the length of individual pores can range from about 50 nm to several micrometers. The thickness of the carbon wall that separates adjacent pores can range from about 2 to 10 nm. Ordered mesoporous carbon thin films are capable of chemical activation for ion-exchange and surface adsorption and can have a surface area greater than about 300 m²/g.

An ordered mesoporous carbon form factor, according to one embodiment, comprises an inorganic scaffold having a coating of ordered mesoporous carbon formed thereon. The inorganic scaffold can have a planar, fibrous, acicular, or tubular structure, and/or can have a reticulated structure, such as a solid foam, honeycomb array, corrugated sheet, etc.

The inorganic scaffold can comprise one or more of a glass or crystalline oxide, carbon (e.g., graphite), nitrides, carbides, etc. A preferred inorganic scaffold material adheres the OMC precursor coating and is configured to mechanically and chemically withstand the steps of coating, drying, cross-linking and heat treating to temperatures in excess of 1200° C. Specifically, a preferred inorganic scaffold material is inert to chemical and thermal decomposition, including melting, and does not undergo uncontrolled or undesired chemical reactions during synthesis of the form factor.

According to a further embodiment, an ordered mesoporous carbon form factor is as described above, but comprises an organic scaffold, a first carbon material (derived from the organic scaffold), and a second carbon material (derived from the carbon precursor). As with the inorganic scaffold, the organic scaffold can have a planar, fibrous, acicular, or tubular structure, and/or can have a reticulated structure, such as a solid foam, honeycomb array, corrugated sheet, etc.

In this embodiment, the organic scaffold can be made of a polymer, such as polyacrylic, polystyrene, or a cellulosic or other organic material, and can comprise organic fibers, including synthetic fibers, that were created into various forms, such as woven fiber fabrics, twine, polymer (plastic) fabrics, polymer foams, sponges, etc.

The organic scaffold preferably adheres the OMC precursor coating throughout the steps of coating, drying, cross-linking and heat treating, and is configured to carbonize within the same temperature regime as the ordered mesoporous carbon precursor while retaining its pre-carbonized structure.

In an ordered mesoporous carbon form factor comprising either an inorganic or organic scaffold, the scaffold preferably functions as a structural support for the ordered mesoporous carbon coating.

### EXAMPLES

The invention will be further clarified by the following examples

### Example 1

### Organic Scaffold Based Form Factors

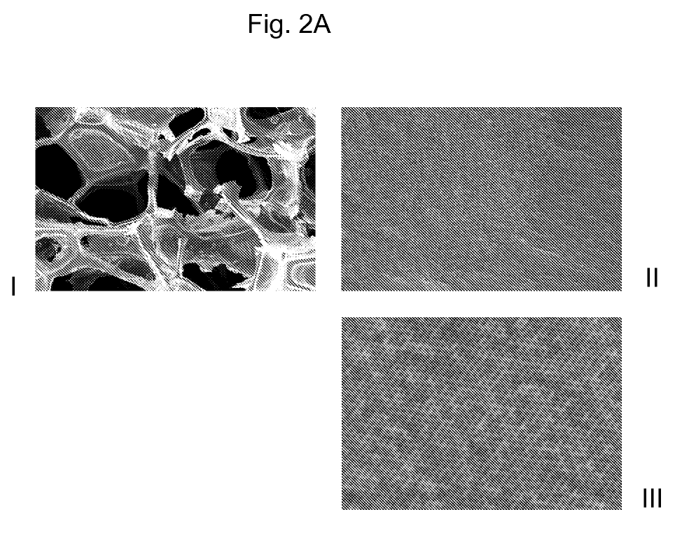

FIG. 2 shows scanning electron micrographs for ordered mesoporous carbon form factors prepared using organic, reticulated scaffolds such as (A) foam, (B) cloth, or (C) paper towel. FIGS. 2(A) and 2(C) each show macroscale images of the foam- and paper-derived ordered mesoporous carbon, and high resolution images of the mesoscale structure. FIG. 2(B) shows high resolution SEM images of the cloth-based ordered mesoporous carbon form factor. The form factors each comprise an ordered mesoporous structure throughout the material, which is retained from the organic template, as well as a macroporous structure corresponding to the starting scaffold. In FIG. 2, the micrographs are shown in increasing magnification from Roman numeral (I) through (III).

Each scaffold was coated by a dip-coating process using precursor mixture A. Excess precursor mixture was removed and each sample was then dried at room temperature overnight. The dried coating was cross-linked by heating according to the schedule disclosed in Table 1, and then heat treated at 900° C. under flowing nitrogen to yield a ordered mesoporous carbon form factor.

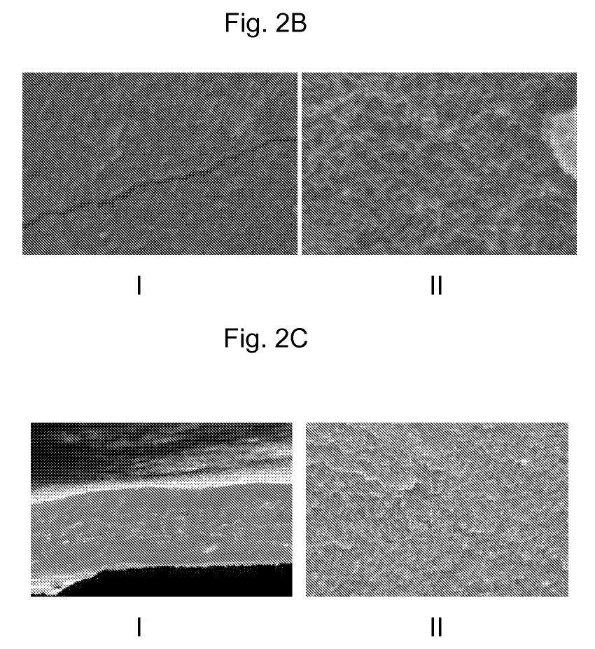

X-ray diffraction (XRD) data for the carbonized foam and carbonized cloth reveal a hexagonally-ordered pore structure. XRD data was also obtained for powder samples of the ordered mesoporous carbon material. FIG. 3 shows a well-resolved d(100) peak at about 90 Å for both the carbonized foam and carbon powder with two higher order peaks corresponding to d(110)˜52 Å and d(210)˜37 Å at 1.7 and 2.4 two-theta, respectively. The XRD intensity for the carbonized cloth is less, which is believed to be due to the relatively low porosity of the material and hence reduced amount of coating. In FIG. 3, the data show X-ray reflections for (a) powder, (b) carbonized foam, and (c) carbonized cloth samples.

### Example 1A

### Carbon-Coated Organic Scaffold (Comparative)

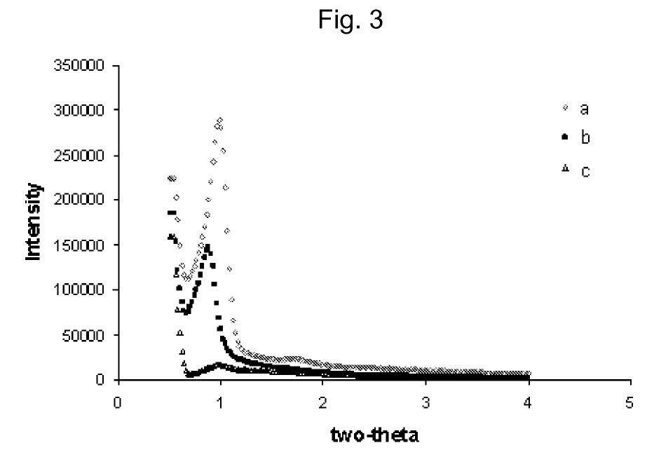

FIG. 4 shows scanning electron micrographs for comparative carbon material prepared using a foam scaffold (as in FIG. 1(A)). In lieu of precursor mixture A, however, a mixture comprising only the carbon precursor was used. Following the same synthesis protocol used for the ordered mesoporous carbon form factors of Example 1, only macroporosity (from the foam scaffold) and some microporosity (250-350 micrometers) were observed in the comparative sample. In contrast to the form factors derived using precursor mixture A, there was no observed mesoporosity, and no ordered mesoporous structure. In FIG. 4, the micrographs are shown in increasing magnification from Roman numeral (I) through (II).

### Example 2

### Free-Standing Ordered Mesoporous Carbon Films

Precursor mixture A (with and without HCl) was coated onto Pyrex® or aluminum substrates, and the solvent was evaporated overnight at room temperature to produce a viscous, yellow layer. Each layer was cross-linked by heating according to the schedule disclosed in Table 1. The cross-linked films were cut to a specified size, placed between two thick plates and carbonized by heating to a pre-determined temperature prior to cooling to room temperature.

As shown by the data in Table 2, from the cross-linked state to the carbonized state, the free-standing ordered mesoporous carbon films exhibit a lateral dimensional change (shrinkage) of about 60% and a weight loss of approximately 75%. The normal thickness change (z dimension) is between 20 and 30%.

TABLE 2
Dimensional change and weight loss for crossing-linking/carbonization.

| | |
|---|---|
| Cross-linked | |
| layer | Carbonized film |

| Sample | x | y | weight | x (loss) | y (loss) | weight (loss) |
|---|---|---|---|---|---|---|
| A | 15.2 | 5.2 | 9.6 | 9.1 (60%) | 3.2 (62%) | 2.57 (73%) |
| B | 15.3 | 5.2 | 9.6 | 9.1 (59%) | 3.1 (60%) | 2.48 (74%) |

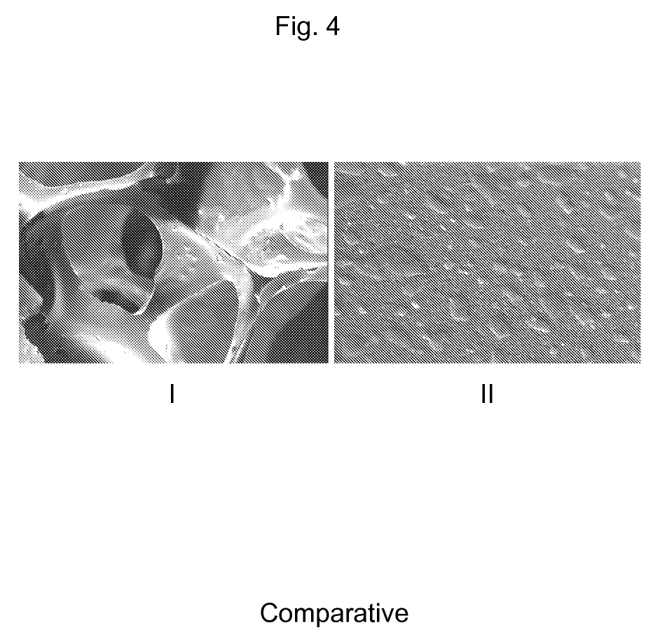

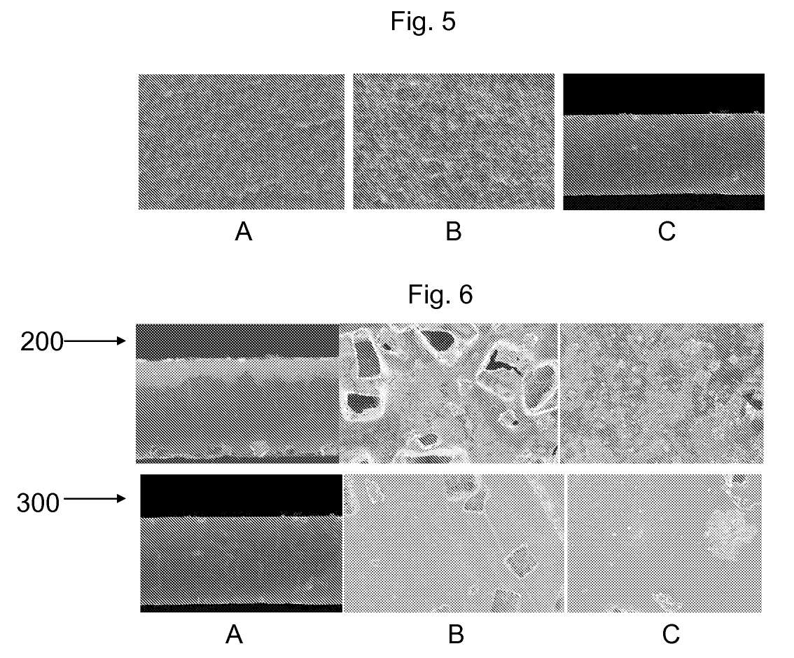

Scanning electron microscopy (SEM) was used to evaluate and measure film geometry, including pore size and orientation. As shown in FIGS. 5 and 6, the thickness of the films deposited on both Pyrex® and aluminum was approximately 125 micrometers, and each free-standing film comprised an ordered mesoporous structure throughout its thickness with pores oriented substantially parallel to the substrate. FIG. 5A shows a cross-sectional image along a top edge, while FIG. 5B shows a cross-sectional image along a bottom edge. FIG. 5C is a cross-sectional view.

The bottom surface texture for the films on Pyrex® substrates was substantially smoother than for films prepared using aluminum substrates. Referring to FIG. 6, cross-sectional (A), top surface (B) and bottom surface (C) images show some texture and, in some cases, macroporosity. In FIG. 6, the substrates are identified by reference numerals 200 (Pyrex®) and 300 (aluminum). Divots observed in the bottom surfaces are the footprints of NaCl crystals, and are due to NaCl in the Georgia Pacific resin.

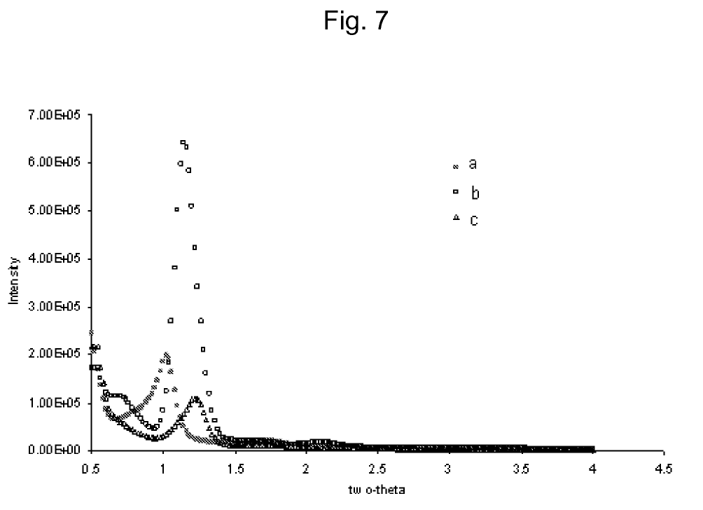

FIG. 7 shows X-ray diffraction plots for ordered mesoporous carbon powder and a free-standing film showing reflections for (a) powder, (b) film top surface, and (c) film bottom surface. As with the form factors in Example 1, X-ray diffraction data for the free-standing carbon films reveal a hexagonal ordering of the pore structure at both the top and the bottom surface of each film. The hexagonal ordering is also observed in the powder sample. Top and bottom surfaces have well-resolved d(100) reflections at 77 Å (top) and 72 Å (bottom), and higher order d(200) peaks at ˜42 Å (top) and 38 Å (bottom).

The powder sample displays a well-resolved d(100) peak at 86.5 Å with a higher order d(110) peak at ˜50.2 Å. Compared to the powder samples, the free-standing films typically exhibit reflections shifted to lower d-spacings suggesting that some compaction takes place during film formation.

Pore volume distribution (PVD) data were obtained by breaking individual free-standing films into smaller pieces. The pore size varies from 2-7 nm with a relatively narrow distribution. The surface area for non-activated samples ranges from about 450-600 m²/g, while the surface area for activated samples ranges from about 1000-1800 m²/g. Mercury porosimetry results show that non-activated films comprise from 60-70% porosity, and that the porosity can be increased to values in excess of 70% by including HCl in the precursor mixture.

To evaluate the electrical properties of the free-standing films, both in-plane and through-plane resistivity measurements were performed. The resistivity measurements comprise applying silver conductive paint to the carbon films to form electrodes, attaching silver wires to the electrodes, measuring resistance with a digital multimeter (4-wire configuration), and calculating the resistivity from the measured resistances using the sample and electrode geometries.

Table 3 shows resistivity and conductivity data for both in-plane and through-plane measurements for samples 1-9. The pH of the precursor mixture in samples 1-9 was varied by controlling the amount of hydrochloric acid used. Though not measured, the pH for samples 1-5 was believed to be in the range of about 1-2. Sample 6 had a pH of 0.96 with a standard deviation of 0.2. Sample 7 was made with no HCl, and had a pH of 8.5 with a standard deviation of 0.2. The pH for samples 8 and 9 was 8.37 and 8.33, respectively. Samples 1-4 and 6-9 were heat treated at 900° C., while sample 5 was heat treated at 1200° C.

TABLE 3
In-plane and through-plane electrical measurements.

| | | | Resistivity | | Conductivity | |
|---|---|---|---|---|---|---|
| | | | [ohm-cm] | | [S cm⁻¹] | |
| Sample | | Thickness | In- | Through- | In- | Through- |
| # | pH | [mm] | plane | plane | plane | plane |
| 1 | — | 0.53 | 0.0249 | 0.1692 | 40.2 | 5.91 |
| 2 | — | 0.49 | 0.0235 | 0.2577 | 42.6 | 3.88 |
| 3 | — | 0.49 | 0.0273 | 0.0916 | 36.6 | 10.92 |
| 4 | — | 0.19 | 0.0106 | 0.1397 | 94.3 | 7.16 |
| 5 | — | 0.21 | 0.0070 | 0.2200 | 142.9 | 4.55 |
| 6 | 0.96 ± 0.2 | 0.29 | 0.0217 | 0.1281 | 46.1 | 7.81 |
| 7 | 8.5 ± 0.2 | 0.24 | 0.0179 | 0.0540 | 55.9 | 18.52 |
| 8 | 8.37 | 0.21 | 0.0158 | 0.5079 | 63.3 | 1.7 |
| 9 | 8.33 | 0.22 | 0.0145 | 0.1306 | 69.1 | 7.66 |

Generally, the resistance increases with increasing film thickness. However, the in-plane resistivity decreases substantially by increasing the heat treating temperature from 900° C. to 1200° C. (sample 5).

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of forming an ordered mesoporous carbon film or form factor, comprising:
forming a precursor mixture comprising a carbon precursor, a surfactant, an oil and water;
depositing the precursor mixture onto a substrate or scaffold to form a coating over exposed surfaces of the substrate or scaffold;
drying the coating and cross-linking the carbon precursor to form a surfactant-based self-assembled template and a carbon precursor-based mesostructure phase that is ordered by the template; and
heat treating the carbon precursor to form an ordered mesoporous carbon film or form factor.

2. The method according to claim 1, wherein the carbon precursor comprises a phenolic resin and the surfactant comprises a tri-block co-polymer.

3. The method according to claim 1, wherein the depositing comprises dip-coating.

4. The method according to claim 1, wherein excess precursor mixture is removed from the substrate or scaffold between the step of depositing and the step of drying.

5. The method according to claim 1, wherein the scaffold has one or more of a planar, fibrous, acicular, tubular or reticulated structure.

6. The method according to claim 1, wherein the substrate or scaffold comprises a porous material.

7. The method according to claim 1, wherein the substrate or scaffold comprises an organic material selected from the group consisting of polymer foams, beads, fibers, sheets and coatings, paper, cloth, and cellulose-based materials.

8. The method according to claim 1, wherein the substrate or scaffold is at least partially volatilized during the step of heat treating.

9. The method according to claim 1, wherein at least part of the substrate or scaffold is incorporated into the ordered mesoporous carbon film or form factor.

10. The method according to claim 1, wherein the ordered mesoporous carbon comprises amorphous carbon.

11. The method according to claim 1, further comprising activating the ordered mesoporous carbon film or form factor.

12. The method according to claim 1, further comprising removing the ordered mesoporous carbon film from the substrate.

13. A free-standing, ordered mesoporous carbon film or form factor, comprising:
an amorphous carbon layer formed over a substrate or scaffold, wherein the carbon comprises ordered domains of mesoscale porosity.

14. An ordered mesoporous carbon film according to claim 13, wherein the substrate comprises a substantially planar surface and the pores are oriented substantially parallel to the substrate surface.

15. An ordered mesoporous carbon film or form factor according to claim 13, wherein the scaffold has one or more of a planar, fibrous, acicular, tubular or reticulated structure.

16. An ordered mesoporous carbon film or form factor according to claim 13, wherein the substrate or scaffold comprises a porous material.

17. An ordered mesoporous carbon film or form factor according to claim 13, wherein the substrate or scaffold comprises an organic material selected from the group consisting of polymer foams, beads, fibers, sheets and coatings, paper, cloth, and cellulose-based materials.

18. An ordered mesoporous carbon form factor according to claim 17, wherein the form factor comprises:
a first carbon material derived from the organic material; and
a second carbon material derived from a carbon precursor, wherein at least one of the first carbon material and second carbon material comprises a plurality of domains of ordered mesoscale porosity.

19. An ordered mesoporous carbon film or form factor according to claim 13, wherein at least part of the substrate or scaffold is incorporated into the ordered mesoporous carbon film or form factor.

20. An ordered mesoporous carbon film or form factor according to claim 13, wherein the ordered mesoporous carbon comprises amorphous carbon.
